(19) United States
(12) Patent Application Publication
(10) Pub. No.: US 2007/0030130 A1
(43) Pub. Date: Feb. 8, 2007

(54) System of proximity sensors for assisting truckers

(76) Inventor: Bobby Ray Creameans, Searcy, AR (US)

Correspondence Address: DENNIS B. HAASE, P.O. BOX 6206, HOT SPRINGS, AR, 71902-6206, US

(21) Appl. No.: 11/198,814

(22) Filed: Aug. 8, 2005

(51) Int. Cl. B60Q 1/00

(52) U.S. Cl. 340/435

(57) ABSTRACT

A proximity and awareness system for large vehicles having blind spots in the operators field of vision. Most importantly, it serves to provide an alert to the driver who, in the process of maneuvering the vehicle may be in danger of contact with an outside agency which may damage the cab of the tractor. The system has an array of sensors strategically disposed about the periphery of the vehicle to focus on blind spots. The sensors communicate with a receiver in proximity to the operator to provide audio signals, visual signals or both to the operator when an object appears in the zone of awareness created by the sensors, warning the operator of impending detrimental contact.

The present invention relates generally to safety assist devices for use on large over the road and off road vehicles such as tractor/trailer systems, also sometimes referred to colloquially as eighteen wheelers, and, more particularly, to such devices that detect impediments to the movement of such vehicles which repose in areas outside the view of the driver while the vehicle is being maneuvered, thereby permitting the driver to avoid potential problems without distracting his attention from control of the vehicle.

### BACKGROUND OF THE INVENTION

1. Field of the Invention

Putting shear size aside for the moment, one of the difficulties in operating a large vehicle, and especially one with a 53 foot van or large box behind the cab, is maneuverability. Add a sleeper cab to the tractor and the problem of blind sports is exacerbated. An operator has limited vision, and typically must rely on side view mirrors in attempting to position the vehicle at a loading dock, or in a parking space at a roadside stop.

As is well known to both operators of such vehicles and those who are on the road behind them, for example, side view mirrors provide good, but not unimpeded visibility. There are inevitable blind spots immediately to the side and rear of the cab, and to minimize those blind spots the operator has few options. For example, he can stop and turn around and look. Since most operators are on tight time schedules, the more common practice is to turn and look while in motion, thereby risking some loss of control, and that, from a safety standpoint, is not acceptable in most instances.

The problem of blind spots in proximity to the cab is not new, as a review of the prior art will attest, but a solution which respects the problems of such blind spots is not so simple.

2. Overview of the Prior Art

In the last 10 years or so, there have been several sensing devices proposed for use by large vehicle operators. Consider, for example, Gauthier U.S. Pat. No. 5,373,482 relating to a plurality of distance measuring sensors on the van of a tractor trailer rig. A similar device is depicted in Studebaker U.S. Pat. No. 5,940,012 where a sensor is at the rear of a van to help the driver determine the distance to the loading dock.

Ehrlich et al. Patent publication No. 2001/0052434 is yet another effort to provide a collision avoidance device for a trailer or van and provides details of the electronics to be employed.

Finally, Juds U.S. Pat. No. 5,463,384 is rather specific to a device mounted on the passenger side door of the cab of a vehicle to detect objects within a zone immediately adjacent to that door.

While these patents, as well as others which have issued from time to time, focus on specific solutions, they do not adequately address the dilemma encountered by the operator of large vehicles when they attempt to maneuver those vehicles into tight spots obscured by lack of adequate visibility.

### SUMMARY OF THE INVENTION

With the foregoing offered by way to setting the environment in which the present invention has particular utility, it is a principal objective of the present invention to provide an improved system for operators of large vehicles which will relieve the stress and improve the safety of efforts to position the vehicle in tight places and including the placement of the rear of the vehicle at a loading dock or the like.

It is another objective of the present invention to provide a system for providing the driver with virtual eyes which can detect and warn an operator of impediments to maneuvering the vehicle, in order that such impediments may be overcome. It is yet another objective, related to the foregoing, to provide such a system which is capable of functioning on either or both sides of the vehicle, and especially behind the cab, to avoid inadvertent collision with the van or other impediment.

It is a more specific objective of the present invention to provide a system which will provide sufficient advance warning to an operator of a large vehicle of the tractor/trailer type that a corner of the cab of the tractor is about to hit either the trailer or some other object which would damage the cab.

Another, and still further, objective of the present invention is to provide a system that is capable of achieving all of the stated objectives, yet is simple to install and easy to operate, with minimal expense to buy.

Other, and further, objectives to be accomplished by the system of the present invention will become apparent to those skilled in the art by virtue of a reading of the following Detailed Description of a Preferred Embodiment, taken in conjunction with the accompanying drawings, wherein:

### BRIEF DESCRIPTION OF THE DRAWINGS

FIG. 1 is a schematic diagram of the principal functional elements of the system of the present invention;

FIG. 2 is a pictorial representation of a typical dash board in a tractor or large truck, depicting a convenient placement of the operator display for indicating what the sensors have determined to be present at their specific locations;

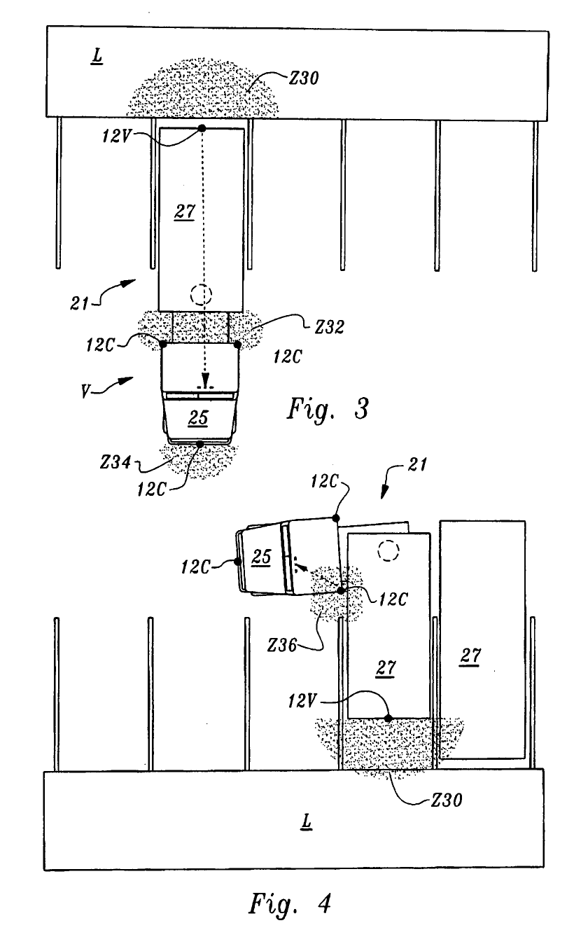

FIG. 3 is a tractor/trailer rig being positioned at a loading dock with a sensor indicating to the driver the relative position of the end of the van; and,

FIG. 4 is a view similar to that of FIG. 3, but illustrating how the system of sensors informs the operator in the tractor of impediments to the maneuver being performed.

### DETAILED DESCRIPTION OF A PREFERRED EMBODIMENT

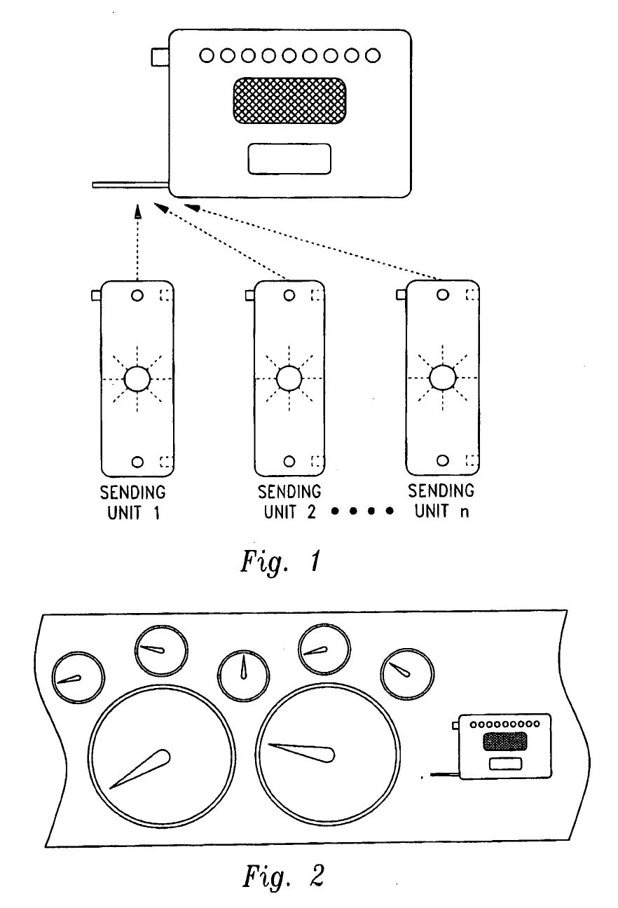

With reference now to the drawings, and initially to FIG. 1, an example of a proximity detection and awareness system 10, constructed in accordance with the present invention, is illustrated.

The system 10, in its simplest form, comprises an array of sensors 12, which are wired, or otherwise configured, with an RF signaling device to a receiver 14 which will provide a warning to the operator of the tractor that contact with an outside agency is eminent and where such contact is about to occur.

The sensors preferably employ passive infra red (PIR) technology to achieve their intended purpose, although other suitable technology will occur to those skilled in the art. The receiver 14 is compact and is readily fitted neatly into the dashboard D of any vehicle to which the system 10 is mounted. The receiver is equipped with an alert warning arrangement, including both audio and visual signals, with individual lights 16 for each sensor 12 providing the visual alert, and a speaker horn 18, or like signal, to provide an audio alert.

The system 10 of the present invention is both simple and easily installed and operated in, for example, on and about the outer surfaces of a tractor/trailer rig 21. Indeed, since the cost of such a system is relatively low, it has utility for any motor vehicle that may, by virtue of inherent blind spots, have need of it. Further, even when the vehicle is parked, or otherwise at rest, it may detect and serve as an alarm against unwanted intruders.

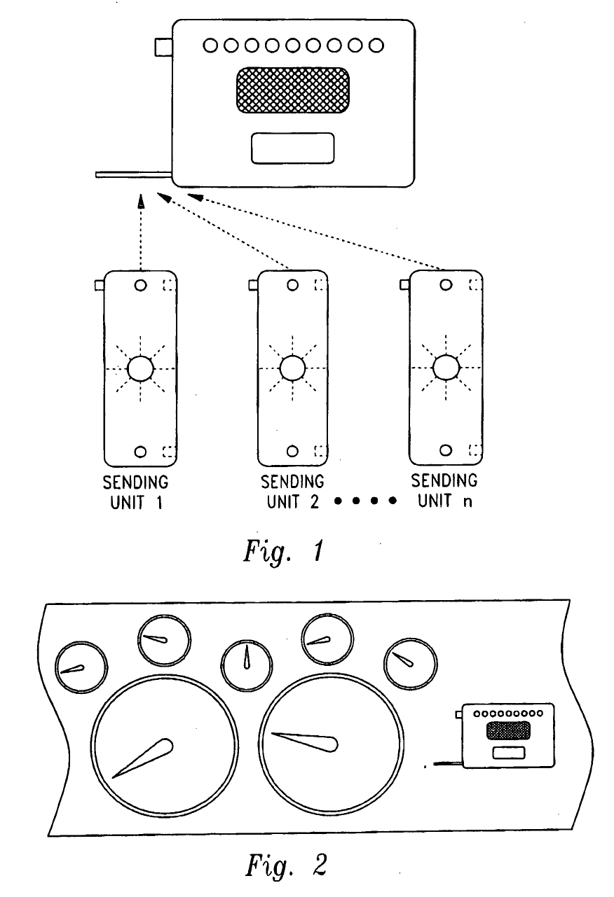

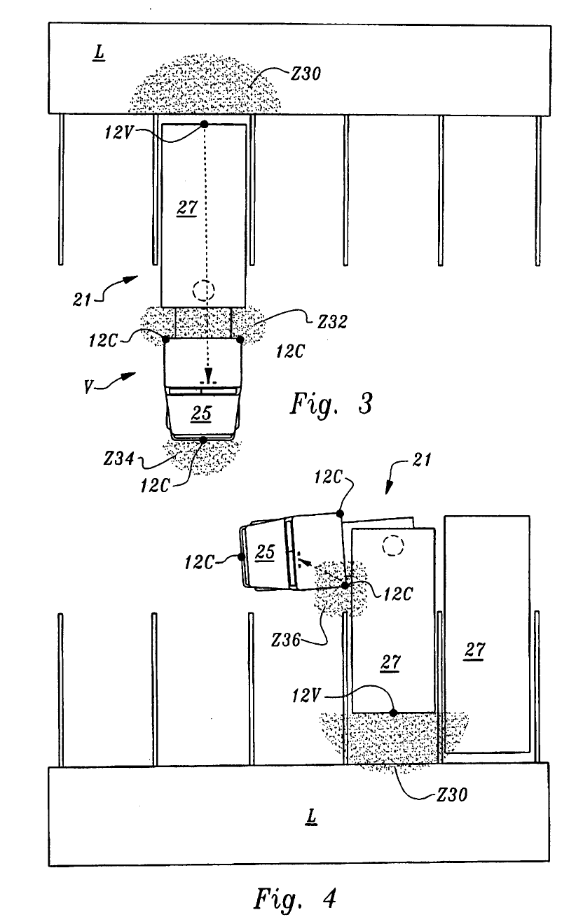

Referring now to FIGS. 3 and 4, an exemplary vehicle V, in the illustrated case, the tractor/trailer rig 21, comprising a tractor 25 and a trailer or van 27. In keeping with the objectives of the invention, an array of sensors 12 is strategically located about the tractor 25 and van 27. Each such sensor is located in a key area to provide the operator with an electronic eye where his or her human eye can not see without being distracted from the vital task of controlling the vehicle.

By way of example, and referring to FIG. 3, one of the more difficult maneuvers for an operator is to back a van or trailer to a loading dock in a narrow space between other vans. To this end, a sensor 12V is positioned at the rear of the van 27, its beam creating a zone Z30 of awareness. As the van 27 approaches the loading dock L, the sensor 12V, which is centrally located on the rear bumper at a central point, will signal the impending contact with the dock, giving the driver a measurement to the loading dock and thereby permitting the operator to bring the van to rest at the appropriate distance without damage to the van or the dock.

In similar fashion, there are sensors 12C located strategically about the perimeter of the cab of the tractor 25. Specifically, there is a sensor on the front bumper near the midpoint and at its lowest point, and two sensors at the rear of the tractor, one on either corner at about the mid point thereof, and at the outermost edge thereof.

Strategic placement of the sensors results in creating additional zones of awareness at Z32 at the immediate rear of the tractor where the sensors will permit the operator to sense the position of the fifth wheel relative to the van, which can only minimally be seen through the rear view mirrors, if at all.

It will also be seen that a zone Z34 is created which increases the awareness of the operator as to objects low and in front of the tractor, typically out of the line of sight of an operator in the cab of the tractor.

Finally, and most importantly, referring to FIG. 4, in the course of maneuvering a vehicle such as that illustrated, the operator is required to cut the tractor sharply to one side or the other. As a result, a corner of the van or trailer may come into contact with the rear of the tractor. In order to minimize this occurrence, the left or right sensor 12V illuminates a zone Z36 which increases the operators awareness, within that zone, of impending, but unintended, contact between tractor and van or other impediment to the safe execution of the maneuver.

As previously alluded to, each sensor is capable of sending a warning signal, either visual or audible, or both, to the receiver 14, and in combination, act in concert, particularly with adjacent such sensors, to provide an operator with an awareness of his or her surroundings which rear view mirrors alone can not hope to create. Thus, the operation of such vehicles becomes much more safe and easier to control than would otherwise be possible.

It will be appreciated that minor variations in the equipment described herein may occur to those skilled in the art. Such variations are within the contemplation of the invention, as described in the following claims.

1. In an large, tractor/trailer type motor vehicle having an operator and rear view mirrors for use thereby, a proximity awareness system about the outer surfaces of the vehicle, said system comprising
an array of sensors, said sensors being strategically mounted about the periphery of the vehicle; each said sensor creating a zone of awareness about the vehicle; said zones of awareness being disposed in areas around said vehicle not readily seen by rear view mirrors;
a receiver in proximity to the operator of the vehicle;
said sensors in communication with said receiver to send an audio or visual signal, or both, to the operator when an object appears in said zone of awareness.

2. The sensor system of claim 1, wherein each said sensor creates a zone of awareness to alert the operator to a possible problem; at least one sensor is so positioned on said tractor relative to said van as to alert the operator in said tractor to impending collision between said tractor and an outside agency such as said van.

3. The sensor system of claim 1 in which sensors are at the front of, and on perimeter of the tractor at the rear thereof.

4. The sensor system of claim 1, wherein a sensor is located at the front of said tractor at the lowest point thereof.

5. The sensor system of claim 1, wherein a sensor is located at the rearmost point of said trailer at the low point thereof.

6. The sensor system of claim 2, in which sensors are at the front of, and on the perimeter of the tractor at the rear thereof;
said sensor at the front of said tractor being located at the lowest point thereof.

7. The sensor system of claim 2, in which sensors are at the front of, and on the perimeter of the tractor at the rear thereof;
a sensor being located at the rearmost point of said trailer at the low point thereof to provide the operator with a zone of awareness at the rearmost point of the vehicle.

8. The sensor system of claim 2, wherein a receiver is mounted in full view of the operator of said tractor, and said sensors being configured to send an audible and visual signal to the driver when contact with an outside agency is within said zone of awareness created by said sensors.
